(19) United States
(12) Patent Application Publication
(10) Pub. No.: US 2013/0093111 A1
(43) Pub. Date: Apr. 18, 2013

(54) Apparatus and Method for the Production of Particles

(71) Applicants: Mustafa Demibüker, Jarfalla (SE); Gérald Jesson, Knivsta (SE)

(72) Inventors: Mustafa Demibüker, Jarfalla (SE); Gérald Jesson, Knivsta (SE)

(73) Assignee: XSPRAY MICROPARTICLES AB, Stockholm (SE)

(21) Appl. No.: 13/704,339

(22) PCT Filed: May 25, 2011
(86) PCT No.: PCT/SE11/00090

§ 371 Date: Dec. 14, 2012

(30) Foreign Application Priority Data
Jun. 14, 2010 (SE) 1000636-9

(51) Int. Cl. B29C 67/00

(52) U.S. Cl. CPC B29C 67/00
USPC 264/12; 425/6

(57) ABSTRACT

An apparatus for the production of particles of a substance by dynamic precipitation of the substance from a fluid solution containing the substance dissolved in a fluid solvent. The apparatus is characterized by comprising A) a first main flow line FL1 (1) intended for a first pressurized fluid F1 and encompassing in its downstream part (dFL1) (38) one, or more dFL1 sub-lines (1a,b,c), where a) every dFL1 subline • comprises one or two serially linked flow-through dispensers for F1 (5a,b,c. and 6a, b, c) and • is functionally equal to the other dFL1 sublines, and b) each of the dispensers • has an inlet (7a,b,c. and 8a,b,c, respectively) and an outlet (9a,b,c. and 1 Oa,b,c . . . , respectively) for flow, and • is functionally equal with the corresponding dispensers in the other dFL1 sublines, and B) a particle formation arrangement (4) comprising a) one or more flow-through particle formation chambers (3a,b,c . . . ), and b) the downstream dispensers (5a,b,c.) of said one or two dispensers (5a,b,c . . . ,6a,b,c.) with one, two or more dispensers per chamber, at least one of the one or two dispensers (5a,b,c . . . ,6a,b,c.) is an injector which is capable of being repeatedly activated enabling a pulsed flow through the outlet of the injector.

### FIELD OF THE INVENTION

This invention relates to an apparatus and/or a method for the dynamic production of particles which contain a substance.

Particles produced according to the invention may be used in a large number of applications, e.g. in pharmaceutical compositions.

### BACKGROUND TECHNOLOGY

The inventive method belongs to generic methods which comprise the step of removing solvent from a pressurized fluid solution containing the substance in a dissolved or suspended or dispersed form by depressurizing or expanding the solution in a particle formation arrangement. The fluid solution may be mixed with one or more other fluids before or during the particle formation step. The particles obtained may be a) porous and/or non-porous, and/or b) hard or elastic including soft, and c) may or may not contain other substances. Particle formation typically comprises precipitation of a substance which is to be incorporated into the particles.

There are two main variants of the generic methods: a) dynamic variants and b) static variants.

In static variant there is no continuous introduction and removal of fluid. The composition of the fluid mixture into the particle formation vessel change with time as more fluid is injected in it. This composition of the fluid mixture at the place where particles formed affects the particles characteristics and thus a static variant is not appropriate for production of consequent batch of powder. A dynamic variant allows working in a steady state where the composition of the fluid mixture does not vary in the particle formation vessel.

A substance that is in dissolved, dispersed or suspended form in a fluid or liquid will be called a solute or a dissolved substance if not otherwise indicated by the context.

Apparatuses and methods aiming at dynamic variants have been described previously (WO 2005061090 CENS Delivery AB; WO 2009072953 XSpray Microparticles AB; and WO 2009072950 XSpray Microparticles AB and publications referred to in these publications).

Leipertz' group has presented experiments in which a static variant has been used for studying particle formation by injecting small aliquots of a solution containing the substance into a large excess of anti-solvent fluid into the particle formation vessel in order not to vary too much the fluid composition (Dowy et al., “Laser Analyses of mixture formation and the influence of solute on particle precipitation in the SAS process” J Supercrit Fluids 50 (2009) 3265-275; Dowy et al., “CO₂ partial density distribution during high-pressure mixing with ethanol in the supercritical antisolvent process” J Supercrit Fluids 50 (2009) 195-202; and Braeuer et al., “Supercritical antisolvent particle precipitation: in situ optical investigations” Chem. Eng. Technol. 33(1) (2010) 35-38).

When producing particles a key goal is often to controllably and reproducibly produce batches of particles in large scale with a high productivity while complying with predefined characteristics which depend on the particular pharmaceutical use and the ingredients of the particles. Typical characteristics comprise physical characteristics, e.g. size characteristics such as mean particle diameter, particle size distribution, morphology etc. For pharmaceutical compositions/formulations and other compositions for biological applications, it is of interest with biological characteristics, e.g. release characteristics of the substance from the particles or the composition, characteristics for in vivo absorption of the particles, of the composition, of a therapeutically active entity etc.

The problems encountered in the field are to a large extent related to the particle formation arrangements used. These arrangements typically have contained a dispenser also called nozzle from which the pressurized solution is expanded into a particle formation chamber through a spray outlet which comprises one or more orifices. By increasing the flow rate in order to increase the productivity the particle characteristics will change. Changing the dimension of the dispenser, e.g. by making it larger, will also cause a change in the characteristics. There is also a risk for variations in particle characteristics over time due to unstable (uncontrolled) flow through the outlet of the dispenser, e.g. due to clogging when depressurizing/expanding fluid solutions through a nozzle into a particle formation chamber. The expanding of the fluid solution through a nozzle will lower the temperature of the dispenser which also will create flow problems, the severity of which will depend on the pressure drop during expansion. For variants utilizing significant pressure drops, such as RESS methods, it is more or less imperative to include a temperature control element in the dispenser.

An important step forward for increasing productivity of high quality particles was applicant's dispenser design with an annular spray outlet for flow and particle formation (WO 2005061090 CENS Delivery AB).

A different suggestion for increasing productivity has been to design the apparatus with several particle formation/collecting chambers and use them one by one in a repetitive sequential mode (WO 1996000610 University of Bradford).

A variant having a higher potential for reaching sufficient productivity has been to equip the apparatus with dispensers working in parallel (WO 2009072953 XSpray Microparticles AB; and WO 2009072950 XSpray Microparticles AB). The dispensers are distributed amongst one or more particle formation/collecting chambers via separate flow lines or via branch conduits deriving from a common main flow line. However, this design is likely to require separate pumps for the individual dispensers in order to render it simple to maintain the same flow through every dispenser and to have a chance to manage with the same particle characteristics from the different dispensers. Separate pumps will be expensive and in the long run likely not to be competitive. A common pump function for the individual branch conduits is likely to require intricate flow control means for securing acceptable inter-conduit and inter-dispenser variations in flow and/or size and/or morphology characteristics of the produced particles. To split a flow in equal parts by branchings can be challenging especially when there is a risk for uncontrolled variations in pressure fall, e.g. by clogging of single dispensers.

None of the modifications above says anything about simplifying the temperature control of the dispenser.

### DRAWINGS

FIG. 1 gives a schematic view of the main flow lines of the inventive apparatus.

FIG. 2 illustrates variants which are primarily adapted to Solvent-AntiSolvent processes (SAS) for the production of particles.

FIG. 3 illustrates further variants which are primarily adapted to SAS-processes.

FIG. 4 illustrates still further variants which are adapted to SAS-processes.

FIG. 5 illustrates variants which are primarily adapted to processes comprising rapid expansion of pressurised saturated fluid solutions (RESS-processes), in particular involving expansion of supercritical solutions, for the production of particles.

FIG. 6 illustrates variants which are primarily adapted to processes comprising spray drying combined with expansion of pressurised fluid solutions for the production of particles.

FIG. 7 illustrates variants which are primarily adapted to the production and coating of particles in the same equipment by SAS-processes.

The same functionality in different figures has the same reference number and is represented by the same symbols.

### OBJECTS OF THE INVENTION

The primary object is to provide apparatuses and methods enabling improvements relating to increasing the productivity when producing batches of particles of predetermined characteristics of the kind discussed elsewhere in this specification. Other objectives include among others:
Improvements relating to avoiding undesired variation in flow and/or in temperature of dispensers present in an apparatus of the above-mentioned kind containing one or more dispensers. The undesired variation may be between functionally parallel dispensers of the kind discussed in WO 2009072953 (XSpray Microparticles AB) and WO 2009072950 (XSpray Microparticles AB) and/or in individual dispensers during operation (time-varied variation).
Improvements relating to lowering the manufacturing costs of apparatuses providing increased productivity.
Improvements relating to obtaining a high productivity of particles complying with predetermined characteristics as discussed elsewhere in this specification.

### THE INVENTION

The present inventors have realized that the above-mentioned problems and objects can be coped with by using dispensers that are able to provide a pulsed flow in order to avoid and/or neutralizing the effect of undesired variations in flow between parallel dispensers and/or time-dependent variations of individual dispensers. A pulsed flow will also reduce undesired chilling of dispensers thereby facilitating temperature control of the particle formation process.

The expression “dispensers that are able to provide a pulsed flow” will in the context of the invention be used synonymously with “injectors” and “actuated flow regulators which are able to provide flow regulation by creating a pulsed flow by controlling the degree of opening of a flow-through channel in some kind of a repetitive manner. The expression encompasses e.g. actuated flow through valves and actuated valve-like devices capable of giving a pulsed flow.

First Aspect: an Apparatus

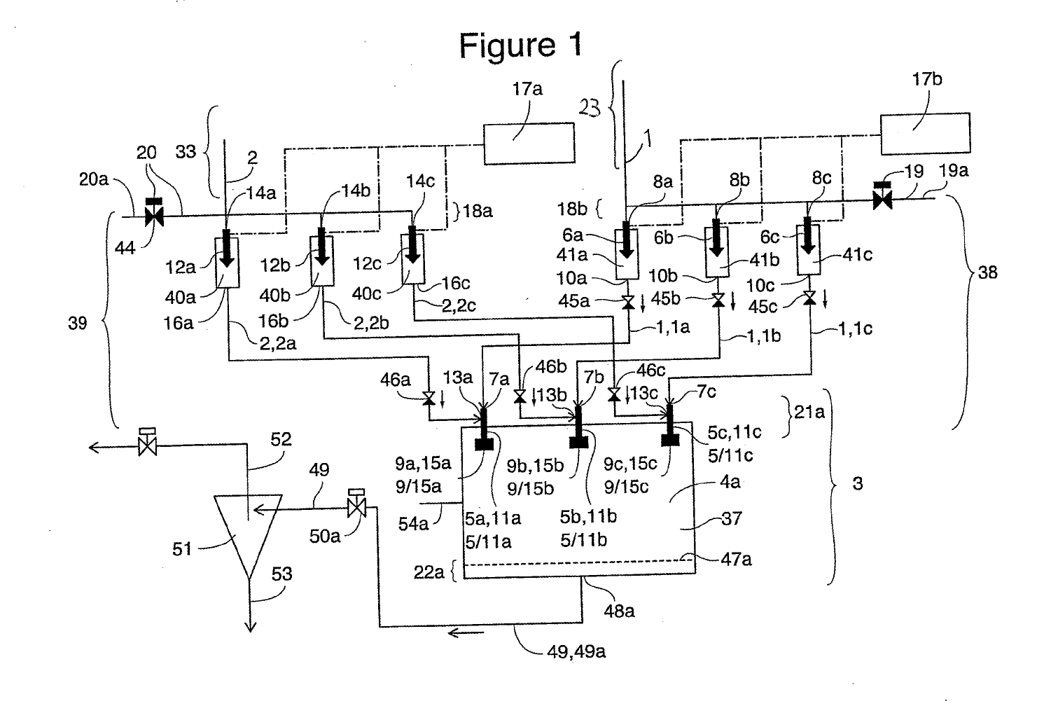

The apparatus of the invention is an apparatus for the production of particles of a substance by dynamic precipitation of the substance from a fluid solution containing the substance dissolved in a fluid solvent. The characteristic features of the apparatus of the invention will now be described based on FIGS. 1-7.

FIG. 1

The main characteristic feature of the apparatus is schematically illustrated in FIG. 1 comprises: As shown in FIG. 1 this feature comprises /
A 1) a first main flow line FL1 (1) for a first pressurized flow FF I of a first fluid F1 (e.g. a fluid solution containing a substance to be incorporated into the particles to be formed),
A2) an optional second main flow line FL2 (2) intended for a second pressurized flow FF2 of a second fluid F2 (e.g. a precipitating or drying fluid), and
B) a particle formation arrangement (3) containing one or more flow-through particle formation chambers (4a,b,c . . . ) (only one chamber (4a) represented in FIG. 1).

The first main flow line FL1 comprises an upstream part uFL1 (23) and a downstream part dFL1 (38) and the second main flow line corresponding parts uFL2 (33) and dFL2 (39).

The first main flow line FL1 (1) encompasses in its downstream part dFL1 (38) one, two or more separate dFL1 sublines (dFL1a, dFL1b etc) (1a,b,c . . . ), where

a) a dFL1 subline
comprises one or two serially linked pressurized flow-through dispensers for F1 (downstream and upstream FL1 dispensers (5a,b,c . . . and 6a,b,c . . . , respectively)), and
is functionally equal to the other dFL1 sublines, and

b) each of said one or two dispensers
has an inlet (7a,b,c . . . and 8a,b,c . . . , respectively) and an outlet (9a,b,c . . . and 10a,b,c . . . , respectively) for flow, and
is functionally equal with the corresponding dispensers in the other dFL1 sublines.

The optional second main flow line FL2 (2) encompasses in its downstream part dFL2 (39) one, two or more dFL2 sublines (dFL2a, dFL2b etc) (2a,b,c . . . ), where

a) a dFL2 subline
comprises one or two serially linked pressurized flow-through dispensers for F2 (downstream and upstream FL2 dispenser) (11a,b,c . . . and 12a,b,c . . . , respectively)), and
is functionally equal to the other dFL2 sublines, and

b) each of said one or two dispensers
has an inlet (13a,b,c . . . and 14a,b,c . . . , respectively) and an outlet (15a,b,c . . . and 16a,b,c . . . , respectively) for flow, and
is functionally equal with the corresponding dispensers in the other dFL2 sublines.

In FIG. 1, a downstream FL1 dispenser (5a,b,c . . . ) is integrated with a downstream FL2 dispenser (11a,b,c . . . ) to a common downstream FL1/FL2 dispenser (5/11a,b,c . . . ) which has a common outlet (9/15a,b,c . . . ) and an inlet arrangement comprising separate inlets (7a+13a;7b+13b; 7c+13c etc) for the two main flow lines.

An important part of the main characteristic feature is that at least one of the one or two serially linked dispensers (5, 6 and 11,12) in the first main flow line FL1 (1) and/or in the second main flow line FL2 (2) are capable of being repeatedly activated enabling transformation of an essentially non-pulsed flow entering the dispenser into a pulsed flow exiting the dispenser through its outlet (=flow-through injector), e.g. by forming a pulsed spray or pulsed jet. In FIG. 1 the upstream dispensers (6a,b,c . . . ,12a,b,c . . . ) in both the first and the second main flow lines are injectors. Flow-through injectors will be simply called injectors in the context of the invention.

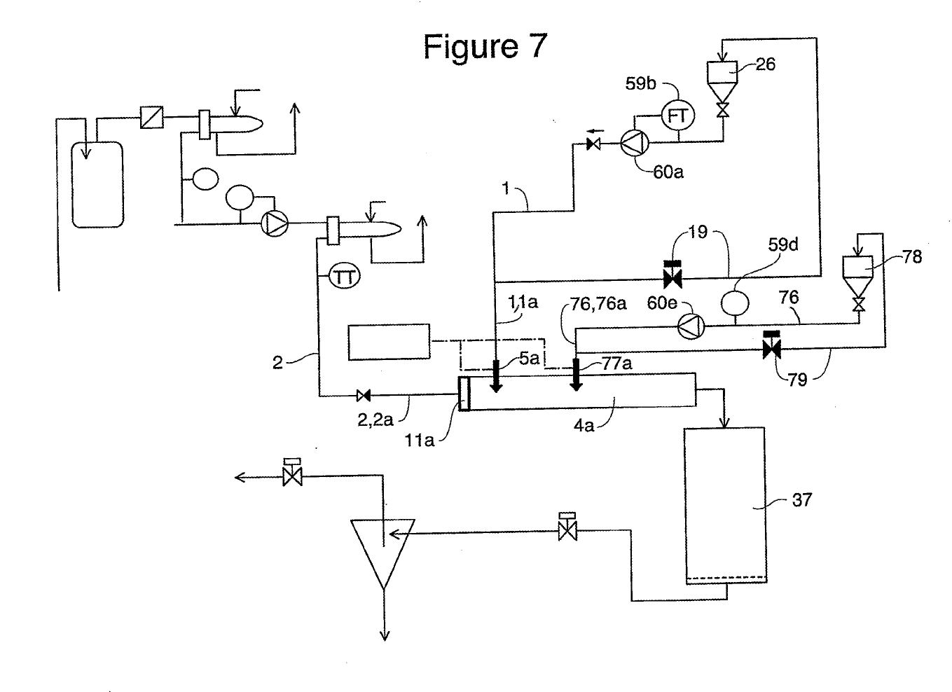

There may also be a third, forth etc main flow line (FL3, FL4 etc). Everyone of these additional main flow lines contains functionally equal sublines terminating in a particle formation chamber and has dispensers as generally outlined for FL1 and FL2. These additional main flow lines may be used for introducing agents modifying the particles formed and/or a substance to be incorporated into the particles. The connection to a particle formation arrangement/chamber may be at the same position as either FL1 or FL2 or at a position that is downstream of the position at which FL1 and/or FL2 is connected. See for instance FIG. 7.

Dispensers

The outlet end of every subline (1a,b,c . . . ; 2a,b,c . . . ) in a main flow line (FL1 or FL2; (1,2)) comprises a dispenser which is called the downstream dispenser (5a,b,c . . . ,11a,b,c . . . ) even if the subline is devoid of an upstream dispenser. The outlet (10a,b,c . . . ,16a,b,c . . . ) of an upstream dispenser (6a,b,c . . . , 12a,b,c . . . ) is in downstream fluid communication with the inlet (7a,b,c . . . ,13a,b,c . . . ) of a downstream dispenser (5a,b,c . . . ,11a,b,c . . . ) (=serially linked dispensers). The outlet (9a,b,c . . . ,15a,b,c . . . ) of a downstream dispenser (5a,b,c . . . ,11a,b,c . . . ) is in direct downstream fluid communication with a particle formation/collecting chamber (4a) of the particle formation arrangement (3). Every downstream dispenser in one of the two main flow lines may be integrated with a downstream dispenser in the other main flow line to a common FL1/FL2 dispenser (5/11a,b,c . . . ) with a common outlet (9/15a,b,c . . . ) (see above).

Dispensers at corresponding positions in different sublines in the same main flow line are functionally equal, i.e. the dFL1 downstream dispensers are functionally equal, the dFL1 upstream dispensers are functionally equal, the dFL2 downstream dispensers are functionally equal etc.

A flow-through dispenser in the form of an injector may be present in either the first main flow line FL1 (1), the second main flow line FL2 (2), or in both. It may be at least the upstream or at least the downstream dispensers.

Preferred injectors are of the same kind as used in diesel engines.

The flow dispensed from an injector may be continuous or discontinuous and includes that 30 the flow exiting an injector comprises repetitive time periods of an increased flow rate alternating with time periods of a decreased flow rate. A decreased flow rate includes that the flow may be stopped, i.e. zero flow rate.

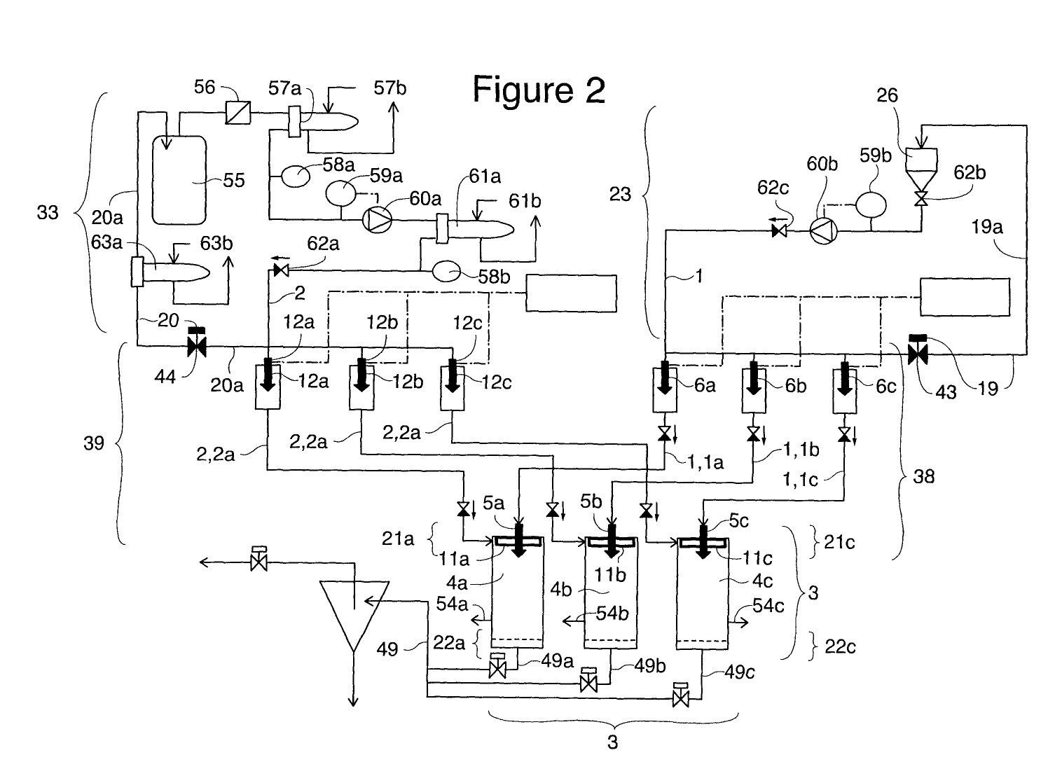

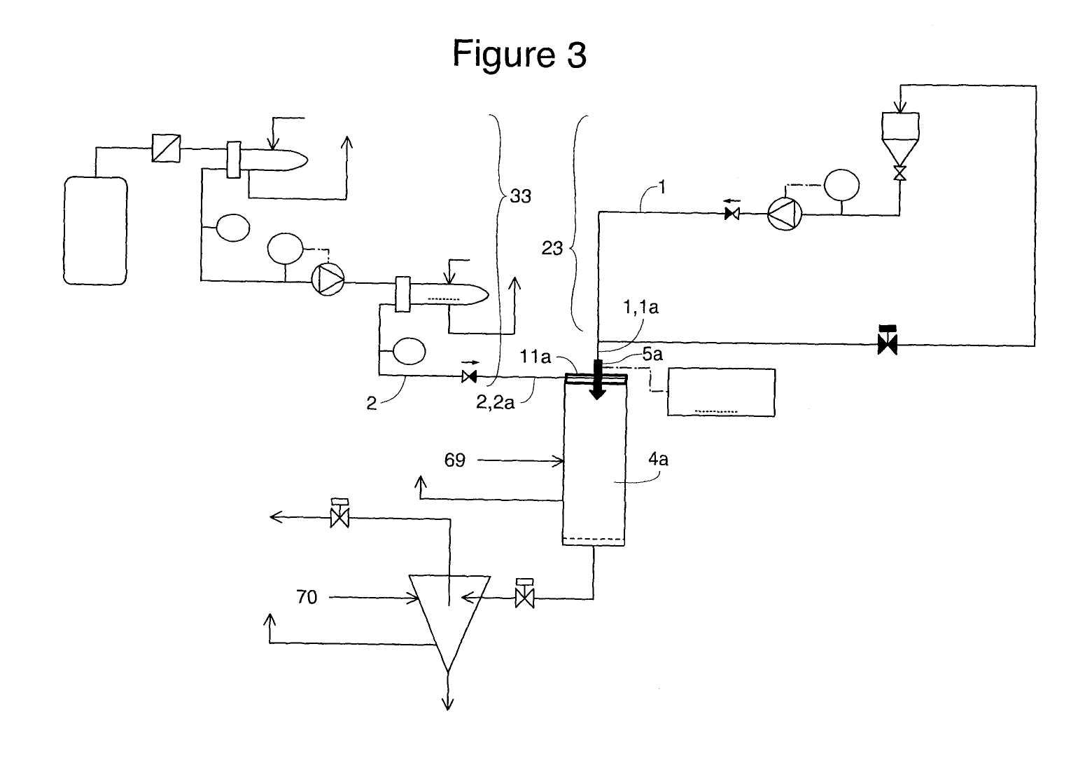

The activation of the injectors is regulated by a pulse control function (17a+17b) enabling adaptation of the pulses for corresponding injectors in different sublines or different main flow lines to occur in a timely suitable fashion. Thus the pulses of corresponding injectors, i.e. injectors at the same position in the sublines of the same main flow line, may occur synchronously with one, two, three or more of them in parallel and/or with one, two, three or more of them delayed relative to each other or relative to the pulses of injectors at a different position of the same main flow line. Parallelism and/or delay may also be relative to pulses of injectors in different main flow lines, e.g. a) downstream injectors of different main flow lines, b) upstream injectors of different main flow lines, and/or c) downstream injectors of one main flow line and upstream injectors of another main flow line. There is typically an electronic pulse co ntrol function which may be common to both main flow lines or as illustrated in FIG. 1 separate for each of them (17a for FL2 and 17b for FL1). This control function is part of a main control function (controller) that may as outlined in FIGS. 2 and 3 include other control functions for the apparatus, for instance a) temperature control functions for dispensers other than injectors, particle formation chamber(s) (69), separation functions (70), various parts in the upstream parts of flow lines (57a,b,61a,b,63a,b), b) temperature sensors (58a,b), c) flow meters (59a,b) etc.

Depending on amplitude and frequency of the pulses it may be advantageous to associate injectors with a pulse damping function in order to secure a sufficiently low variation in flow during formation of the particles. Pulse damping in a subline containing an injector can be accomplished by including an enlargement (40a,b,c . . . ,41a,b,c . . . ) of the subline within the injector or at a position downstream of the injector (e.g. between an upstream injector and a downstream dispenser).

Dispensers in the main flow lines which are not injectors may be selected from other kinds of flow-through dispensers, such as diffuse dispensers, spray dispensers etc. These other flow-through dispensers give a non-pulsed flow and are called non-actuated dispensers or non-actuated nozzles. During operation of the apparatus of the invention, they typically give a non-pulsed flow e.g. an essentially constant flow. The term “non-actuated dispenser” includes injectors which can be used without actuation, i.e. when they are used for dispensing a fluid flow without pulsing. Diffuse dispensers are also called diffusers in this specification.

Diffuse dispensers also called diffusers are primarily useful as downstream dispensers and provide the fluid into the particle formation chamber via a perforated or porous outlet, for instance in the form of a plate. Diffuse dispensers may also be used as upstream dispensers with the perforated or porous outlet typically covering the cross-sectional area of the flow line or a part thereof at the outlet of the upstream dispenser.

Spray dispensers may be used as a) downstream dispensers and provide partly depressurized fluid to the particle formation chamber or b) upstream dispensers and provide partly depressurized fluid to a downstream section of a subline. Typical spray dispensers that can be used are described in the publications cited in this specification (e.g. WO 2005061090 CENS Delivery AB; WO 2009072953 XSpray Microparticles AB; and WO 2009072950 XSpray Microparticles AB and publications cited in these publications).

What has been said about dispensers of main flow lines FL1 and FL2 also applies to main flow lines other than FL1 and FL2, i.e. FL3, FL4 etc. A downstream dispenser may or may not be part of a common downstream dispenser in which there is a common outlet for downstream dispensers of two or more main flow lines (coinciding outlets).

Sublines and other Flow Lines

Functionally equal sublines are defined as containing essentially the same functionalities arranged in the same relative order. Sublines do not need to be geometrically parallel.

For variants in which the downstream part of a main flow line (dFL1 and dFL2) (38 and 39, respectively) comprises two or more sublines (dFL1a,b, etc or dFL2a,b, etc) (1a,b,c . . . and 2a,b,c . . . ) there is also a segment (18a and 18b) in which the main flow line is divided/branched into the sublines (1a,b,c . . . and 2a,b,c . . . ) (branching segment (18a and 18b)) at one or more position. In the downstream direction the branching may be into two or more branch conduits (primary branch conduits) at a first position, one or more of which may be further divided into branch conduits (secondary branch conduits) at one or more positions etc finally ending in a number of unbranched branch conduits. Every one of these unbranched branch conduits which contains the above-mentioned one or two serially linked dispensers is a subline of the kind defined above. Using an injector as one of the one or two dispensers in every subline will facilitate the flow control discussed above for this kind of branched systems and support a secure and simplified control of the size and/or morphology characteristics of the particles produced (compare WO 2009072953 XSpray Microparticles AB; and WO 2009072950 XSpray Microparticles AB).

A subline as defined above may contain branchings. Thus a subline may contain branchings for the introduction of fluids into the subline, for taking care of increase in pressure upstream of injectors (e.g. as part of a return flow line) etc. See below.

In variants in which a main flow line contains only one subline, this subline is a single extension of the upstream part of the main flow line, e.g. of the first or second main flow line (FL1 or FL2). See FIGS. 3 (FL1 och 2), 4 (FL2) and 5 (FL1).

A subline may in addition to the above-mentioned one or two dispensers also contain other functionalities, such as one or more additional dispensers, as long as sublines of the same main flow line remain functionally equal. In other words if an extra functionality is present in one subline of a main flow line, an equal functionality is typically also present in everyone of the other sublines of the same main flow line.

As illustrated in FIG. 2-7 (in particular 2, 5 and 7), the flow through each main flow line is typically driven by a pump function (60a,b,c) associated with the upstream part of each main flow line. This pump function typically provides separate control of the flow in the different main flow lines, e.g. FL1 and FL2 (1,2). The pump function may for instance have one pump (60b,c) for first main flow line FL1 (1) and another pump (60a) for the second main flow line FL2 (2).

The use of an injector connected to a pump function to induce pulses in the flow downstream of the injector may create a continuous step-wise pressure increase in a main flow line upstream of an injector. An injector is therefore preferably associated with an excess function (19 for FL1 and 20 for FL2) taking care of this increase in pressure.

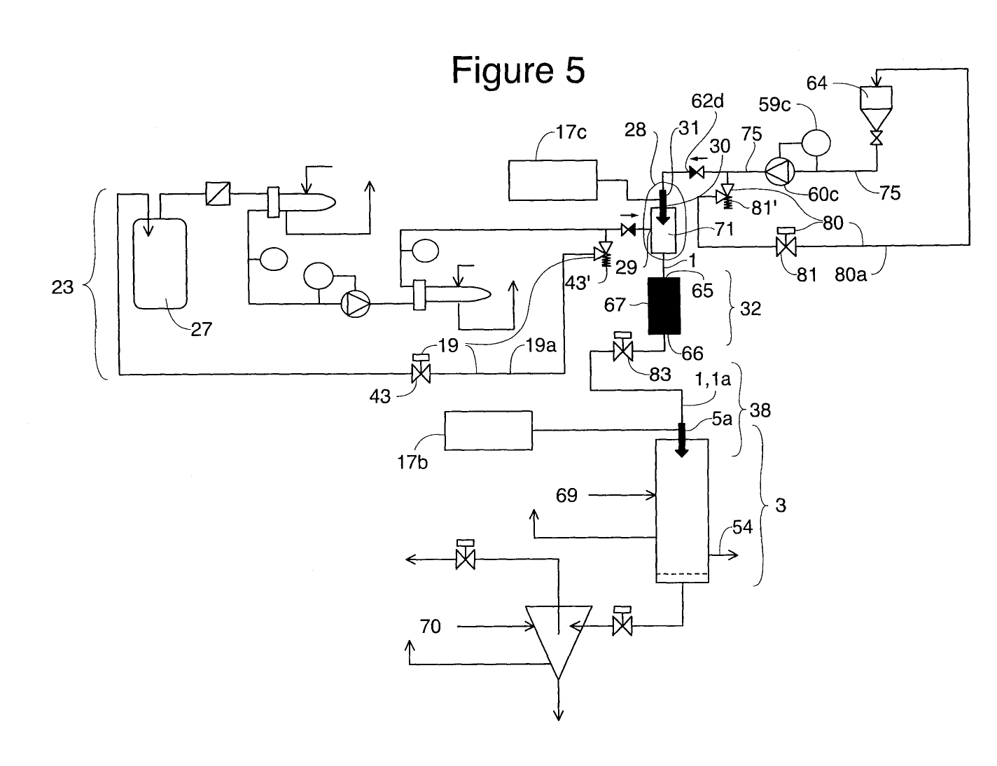

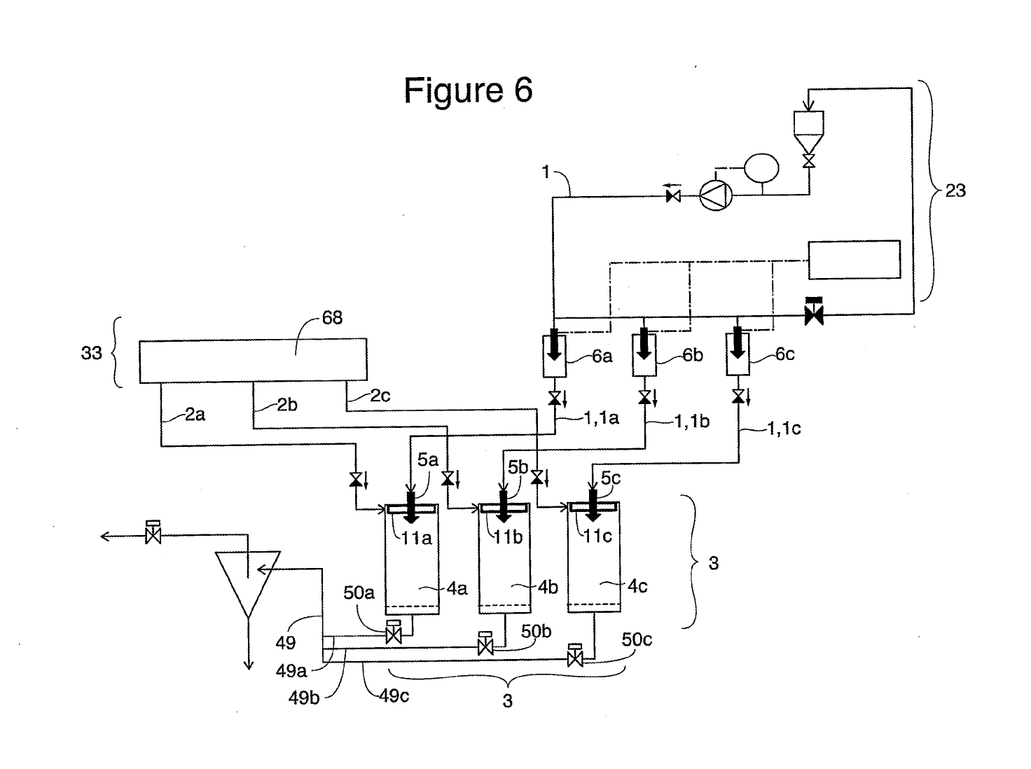

A typical excess function of this kind comprises an excess flow line (19a for FL1 and 20a for FL2) preferably in the form of a return flow line returning excess flow from the main flow line (1,2) to a storage container (26 and 55, respectively) for the fluid concerned. This kind of excess function is placed upstream of an injector with the start (inlet end) of its excess flow line preferably placed at a position upstream of the injector, i.e. within the subline containing the injector or within the branching segment (18a,b) or within the upstream part (23,33) of the main flow line containing this subline. The start may in some variants also be within an injector. In variants in which a subline has two serially linked dispensers and the injector is the downstream dispenser, the start of the excess flow line, such as a return flow line, may be between the injector and the upstream dispenser. An excess flow line, such as a return flow line, typically comprises a back pressure regulator (43 for FL1 and 44 for FL2) and/or a pressure release valve function (43′, FIG. 5) (see also FIGS. 2-7 including also similar excess systems for other flow lines, i.e. excess functions 80 comprising 80a, 81 and 81′ in FIG. 6, and excess function 79 in FIG. 7).

Between two serially linked dispensers there is typically a check valve (45a,b,c . . . for dFL1 sublines and 46a,b,c . . . for dFL2 sublines).

What has been said above for functions in sublines with respect to main flow lines FL1 and FL2 also applies to other main flow lines (FL3, FL4 etc) that may be present.

The particle formation arrangement

The particle formation arrangement (3) comprises:
a) one or more flow-through particle formation chambers (4a,b,c . . . ) every one of which has an inlet arrangement (21a,b,c . . .) and an outlet arrangement (22a,b,c . . . ) (several chambers in FIGS. 2 and 6), and
b) the downstream dispensers (5a,b,c . . . ,11a,b,c . . . and 5/11a,b,c . . . ) of the main flow lines FL1 (1) and FL2 (2) (if present).

A downstream dispenser is part of the inlet arrangement of a particle formation chamber and provides downstream fluid communication between a main flow line FL1 or FL2 and the chamber

A downstream FL2 dispenser (11a,b,c . . . ) if present may be fluidly connected to a particle formation chamber (4a,b,c . . . ) in either of two ways:
i) via a downstream FL1 dispenser (5a,b,c . . . ), i.e. at least the outlet (15a,b,c . . . ) of the downstream FL2 dispenser (11a,b,c . . . ) is part of (=coincides with) the outlet (9a,b,c . . . ) of a downstream FL1 dispenser. (5a,b,c . . . ) (common FL1/FL2 dispensers (5/11a,b,c . . . )) (FIG. 1), or
ii) directly into the particle formation chamber (4) (FIGS. 2-6).

The inlet arrangement (21a) of a chamber comprises for both alternatives a mixing arrangement permitting mixing of flow originating from the first main flow line FL1 (1) with flow originating from the second main flow line FL2 (2). In alternative (i) the mixing is starting within the dispenser and in alternative (ii) within in the particle formation chamber.

Alternative (i) above means, as illustrated in FIG. 1, that a downstream dispenser (5a,b,c . . . ) of a dFL1 subline (1a,b,c . . . ) and a downstream dispenser (11a,b,c . . . ) of a dFL2 subline (2a,b,c . . . ) are integrated with each other to a common FL1/FL2 dispenser (5/11a,b,c . . . ) with a common spray outlet (9/15a,b,c . . . ) for flow into the particle formation chamber (4a,b,c . . . ). The flow of a dFL1 subline (1a,b,c . . . ) and the flow of a dFL2 subline (2a,b,c . . . ) are thus merged with each other within the common dispenser. The angle between the two flows at the merging is preferably in the interval of 0-180°, such as 45-135°. These ranges typically also apply to the angle for the merging between the dFL1 subline and the dFL2 subline carrying these flows. For applicant the most preferred dispenser variants of this kind have an annular spray outlet which gives an annular outlet flow of the F1/F2 mixture.(WO 2005061090, CENS Delivery AB; WO 2009072953, XSpray Microparticles AB; and WO 2009072950, XSpray Microparticles AB). A special variant comprises dispensers in which the dFL1 subline and the dFL2 subline are merging with each other within the dispenser at an angle of 0° to a combined spray outlet, with preference for the two sublines being coaxial with each other at the merging position (WO 1996000610 University of Bradford).

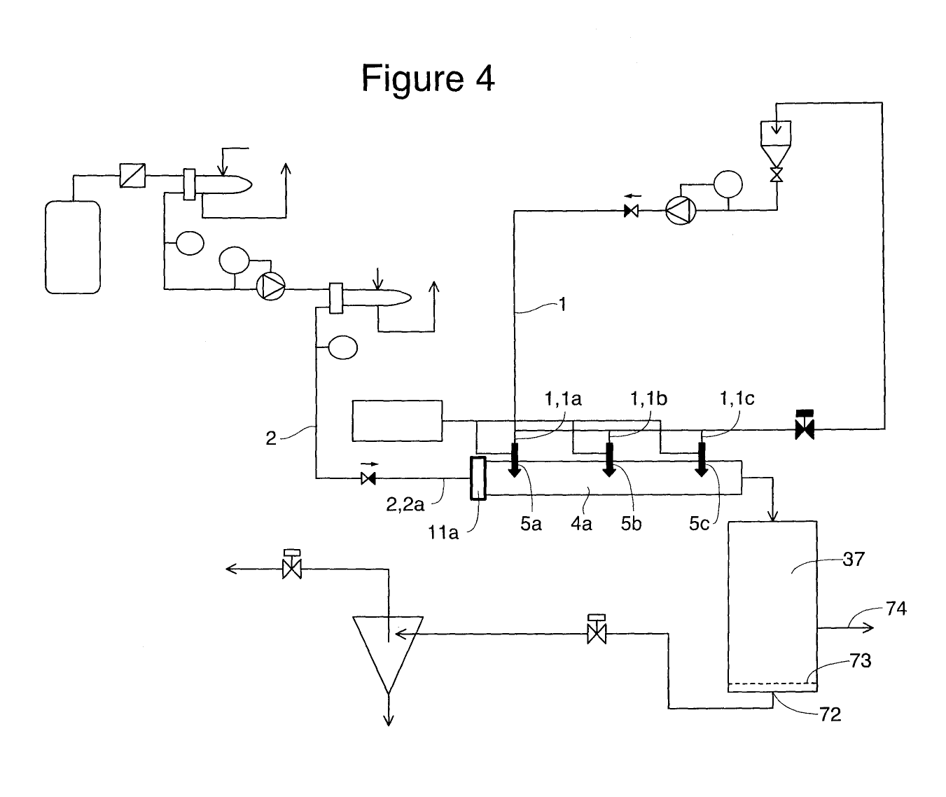

Alernative (ii) above means as illustrated in FIGS. 2-7, that the outlet (9a,b,c . . . ) of a downstream FL1 dispenser (5a,b,c . . . ) is separate from the outlet (15a,b,c . . . ) of a downstream FL2 dispenser (11a,b,c . . . ) at their fluid communication with a particle formation chamber (4a,b,c) (FIGS. 2-7). The two dispensers are typically arranged to provide an angle between the outlet flows from these two dispensers at their inlet into the particle formation chamber within in the interval of 0-180°, such as 45-135° or 0-15° or 80-100° or 165-180°. For cylinder-like chambers, a flow from a dFL2 subline (2a,b,c . . . ) may enter the chamber via the cylindrical wall while a flow from a dFL1 subline (1a,b,c . . . ) may enter through the bottom or the top of the cylinder, or vice versa with the dFL1 subline flow entering through the wall and the dFL2 subline flow through the bottom or top. A flow entering the particle formation chamber via a cylindrical wall may be tangential or radially inwards, or in any direction between tangential and radial inwards and possibly containing also an axial component (=longitudinal component). An inlet flow through the top or bottom of a cylindrical chamber may contain only an axial component or both an axial and a radial component. A merging angle of 90° is given in FIG. 4 and of 0° in FIGS. 2,3,5 and 6 where the merging angle is the angle between the directions of the two flows at their entrance into the particle formation chamber.

The number of downstream dFL1 dispensers (5a,b,c . . . ) and the number of downstream dFL2 dispensers (11a,b,c . . . ) connected to an inlet arrangement or a chamber (21a,b,c . . . /4a,b,c . . . ) may differ from each other or be the same (presuming main flow line (FL2 is present). These numbers are typically within the interval of 1-12 which also applies to combined FL1/FL2 dispensers (5/11a,b,c . . . ). See FIGS. 1-7.

What has been said above about main flow lines FL1 and FL2 within the inlet arrangement (21a) also applies to additional main flow lines if they are present.

The apparatus may contain one, two or more particle collection vessels (37a,b,c . . . ) everyone of which is placed downstream of or is fully or partially coinciding with a particle formation chamber (4a,b,c . . . ). For variants containing several particle formation chambers a particle collection vessel may be common for two or more of these chambers. Variants in which the particle formation chamber and particle collection vessel are physically separated are illustrated in FIGS. 4 and 7.

The outlet arrangement (22a,b,c . . . ) of a particle formation chamber/collecting vessel (4a,b,c . . . /37) typically comprises a particle receptor function (47a,b,c . . . ) for separating the formed particles from the fluid phase and an exit (48a) with an exit flow line (49a) for carrying fluid leaving the particle formation chamber/vessel (4a,b,c . . . /37) further downstream. The exit flow line(s) (49a,b,c . . . ) are typically part of a main exit flow line (49) combining exit flow from several particle formation chambers if present. This main exit flow line (49) typically has a back pressure regulator (50a,b,c . . . ) for regulating the pressure inside the particle formation chamber/collecting vessel (4a,b,c . . . /37). See also FIGS. 2-7).

A particle formation chamber/collecting vessel (4a,b,c . . . /37) typically also comprises a function (54a,b,c . . . ) through which the particles formed can be harvested. See also FIG. 2.

As illustrated in FIGS. 3 and 5, the temperature of the particle formation chamber (4a) may be controlled by a suitable heating/cooling arrangement (69), e.g. based on heat exchange.

The main exit flow line (49) may in its downstream part have a fluid separating function (51), e.g. a cyclone, capable of separating fluids forming separate phases from each other, if such fluids are present in the fluid entering this function and the desire is to separate them from each other. The separating function (51) typically works as a phase separator and is preferably a cyclone The separating function fractionate the exiting fluid into two phases enriched in for instance fluid F1 and fluid F2, respectively, if the second main flow line FL2 (2) is present and used with fluid F2. Downstream of the separating function (51), the main exit flow line (49) will continue as at least two sublines (52,53), e.g. one for fluid enriched in F1, and/or one for fluid enriched in F2. If desired, one or both of these fluids may be recirculated to storage vessels in the upstream parts of the main flow lines FL1 and FL2.

As illustrated in FIGS. 3 and 5, the temperature of the separating function (51) may be controlled by a suitable heating/cooling arrangement (70), e.g. based on heat exchange.

The pressure release valves discussed above and below and the temperature of the particle formation may be controlled by the controller of the apparatus.

Upstream Parts of the Main Flow Lines

Either one or both of the upstream parts uFL1 (23) and uFL2 (33) may be designed for a supercritical fluid or a subcritical fluid. This means that each of them preferably may comprise the various functions outlined in FIG. 2 for the upstream and downstream parts.

Each of the upstream parts thus comprises a storage vessel (26 for uFL1 (23) and 55 for uFL2 (33)), respectively) for the fluid concerned (FIG. 2). At least one of the fluids, for instance F1 or F2, may comprise the substance, e.g. as a solute, before the fluid is introduced into the apparatus. Alternatively the substance is added to the fluid within the apparatus, for instance in an extraction function as discussed elsewhere in this specification (FIG. 5).

One or both of fluid F1 and fluid F2 may be a mixture of fluids prepared within the device as illustrated in FIG. 5 from two or more different fluids, e.g. F1 by mixing F′1 with F″1 and/or F2 by mixing F′2 with F″2. In this case there may be separate storage vessels and flow lines for the different fluid components needed. Main flow line FL1 will then be the flow line carrying the fluid component which constitutes the largest proportion in the fluid F1 at the inlet (7a,b,c . . . ) of the downstream FL1 dispensers (5a,b,c . . . ). This definition also applies to FL2 except that F1 and FL1 is replaced with F2 and FL2. Mixing of fluids is preferably taking part in the upstream part of a main flow line, i.e. in uFL1 (23) and/or uFL2 (33). Alternatively mixing can be carried out in the sublines of the main flow line concerned (not shown). This will, however, require branching of the flow line carrying the fluid component to be mixed with the fluid in the main flow line and/or an intricate flow control to mix the same proportions in all sublines of a main flow line.

A fluid to be mixed with the fluid transported in a main flow line typically comprises an agent modifying the particles formed. This means that the modifying agent can be the fluid as such or an agent added to the fluid. Modifying agents are further discussed below.

The mixing function and/or an extractor function discussed for the variants represented by FIG. 5 below may also be present in variants discussed in the context of FIGS. 1-4 and 6-7 (not shown).

In the case main flow lines other than FL1 and FL2 are present they may contain upstream parts as discussed above (not shown).

FIG. 2

This figure illustrates variants of apparatuses according to the invention primarily adapted to solvent-anti-solvent processes (SAS). The variants comprises arrangements for providing various kinds of fluids as F1 and F2 in the upstream parts (23,33) of the two main flow lines FL1 and FL2 (1,2). The upstream part uFL1 (23) is adapted for a fluid F1, such as a fluid solution containing the particle-forming substance, e.g. as a solute, in a subcritical state. The upstream part uFL2 (33) is adapted for a fluid F2 in a supercritical state, such as a supercritical anti-solvent fluid.

The upstream part uFL1 (23) illustrates that for subcritical fluids an upstream part of a main flow line may comprise a storage vessel (26) for a fluid in a subcritical state. Downstream of the vessel (26) there may be a valve (62b) for opening or closing the outlet of the vessel, and/or a flow meter (59b), and/or a pump (60b), and/or a check valve (62c).

The upstream part uFL2 (33) illustrates that for variants utilizing supercritical fluids, e.g. CO₂, an upstream part of a main flow line comprises a pressurized storage vessel (55). Downstream of the vessel (55) there may be a filter (56), and/or a heating/cooling unit (57a). e.g. based on heat exchange (57b), and/or a temperature sensor (58a), and/or a flow meter (59a), and/or a pump (60) e.g. a CO₂ pump, and/or a heating/cooling unit (61a) e.g. based on heat exchange (61b), and/or a temperature sensor (58b) and/or a check valve (62a) before the main flow line reaches the downstream part dFL2 (39). Adaptation of the flow line to supercritical conditions is primarily downstream of the pump.

FIG. 2 also illustrates variants in which the particle formation arrangement (3) comprises several parallel particle formation chambers (4a,b,c . . . ) with separate exit flow lines (49a,b,c . . . ) as part of a main exit flow line (49) and separate functions (54a,b,c . . . ) for harvesting the particles formed. The downstream FL1 dispensers (5a,b,c . . . ) are injectors while the downstream FL2 dispensers (11a,b,c . . . ) are diffusers. The outlet of a downstream FL1 dispenser is separate from the outlet of a downstream FL2 dispenser and placed at the entrance of the particle formation chamber. The chambers (4a,b,c . . . ) are typically cylindrical with entrance of both fluids through the top. Both FL1 and FL2 comprise injectors (5a,b,c . . . ,6a,b,c . . . and 12a,b,c . . . , respectively). Therefore there is an excess function (19,20) in both of the two main flow lines. This function comprises a return excess flow line (19a,20a) with a pressure release valve/back pressure regulator (43,44) permitting return of flow to the storage vessels (26,55) as a response to pressure increase upstream of the FL1 injectors (5a,b,c . . . ,6a,b,c . . . ) and FL2 upstream injectors (12a,b,c . . . ). The excess function for the upstream dFL2 dispensers (injectors) comprises a heating/cooling unit preferably based on heat exchange (63a,63b).

The flow meters (59a and 59b) are used to control the pumps (60a and 60b, respectively) to maintain a predetermined flow in the main flow line FL1 and FL2, respectively.

The heating/cooling unit described above and elsewhere in this specification may be designed for only heating, only cooling or both heating and cooling. The demand for heating may be important after depressuring a fluid and for cooling after pressurizing a fluid. Typically, unit (57a+b) is for cooling, unit (61a+b) is for heating, and unit (63a+b) is for cooling.

FIG. 3

This figure illustrates variants of the inventive apparatuses adapted to SAS processes and is similar to FIG. 2. The main differences are:

a) only one dFL1 subline (1a) and only one dFL2 subline (2a),

b) the dFL1 subline (1a) comprises only one dispenser (5a) which is an injector,

c) the dFL2 subline (2a) comprises only one dispenser (11a) which is not an injector,

d) the particle formation arrangement comprises only one particle formation chamber (4a).

The two dFL sublines (1a and 2a) are downstream extensions of the upstream part of main flow line FL1 and main flow line FL2, respectively.

Only main flow line FL1 (1) comprises the excess function (19). This function is missing in the other main flow line (FL2 (2)) because this flow line is devoid of an injector (the only FL2 dispenser is a diffuser (11a).

The upstream part of FL1 (23) and the upstream part of FL2 (33), are in principle the same as the corresponding parts in FIG. 2.

FIG. 4

This figure illustrates still other variants of the apparatuses of the invention. The variants primarily are adapted to SAS processes. The figure is similar to FIGS. 2 and 3. The main differences are:
a) the number of dFL1 sublines (1a,b,c) differs from the number of dFL2 sublines (2a),
b) the angle between the dFL1 subline and the dFL2 sublines at their entrance of the particle formation chamber is 90° (dFL1 subline enters through the top of a cylindrical chamber (4a) and the dFL2 sublines through the cylindrical wall),
c) presence of a particle collection vessel (37) having an exit (72) for fluid, a function (73) for separating the particles formed from the fluid and a function (74) for harvesting the particles after the fluid has been removed from the vessel, and
d) the downstream dFL1 dispensers (5a,bc . . . ) are placed at increasing downstream positions in the wall of the particle formation chamber (4a) relative to the position of a downstream dFL2 dispenser (11a).

The feature according to (d) is believed to be advantageous in particular if main flow line FL1 contain downstream dispensers that are injectors and is intended for the fluid solution and main flow line FL2 is intended for the anti-solvent fluid.

FIG. 5

This figure illustrates variants which are primarily adapted to particle formation by rapid expansion of pressurized saturated fluid solutions (RESS) with particular emphasis of expansion of supercritical solutions. Apparatus variants intended for these processes do not need to have two main flow lines. It suffices in many cases with only one (FL1 (1)). The injector required by the present invention is present in one of the main flow lines that are present, i.e. in FL1 or FL2 (provided main flow line FL2 is present), e.g. in the FL1 and/or the FL2 sublines and/or possibly combined with injectors in an FL1 and/or FL2 upstream part.

The main flow line (1) in FIG. 5 has a downstream part dFL1 (38) with one subline (1a) which comprises only one FL1 dispenser (5a) which is an injector in downstream fluid communication with a particle formation arrangement (3) as outlined in FIG. 1-4. In other variants main flow line FL1 may comprise one or more dFL1 sublines (1a,b,c . . . ) and one or two dFL1 dispensers (5a,b,c . . . ;11a,b,c . . . ) per dFL1 subline as outlined in FIGS. 1-4.

In FIG. 5 main flow line FL1 (1) has an upstream part uFL1 (23) which comprises a storage vessel (27) and various arrangement that may or may not be adapted for transportation of a fluid in a supercritical state, i.e. designed as described for the upstream part of FL2 in FIGS. 2. In an alternative the upstream part of FIG. 5 may be adapted to subcritical fluids or liquids such as described for the upstream part of main flow line FL1 in FIGS. 1-2.

From the storage vessel (27) a fluid F′1 transported downstream in FL1 (1) to an optional mixing function (28) in which F′1 is mixed with a fluid F″1 possibly comprising a modifying agent of the kind described elsewhere in this specification. The mixing function (28) may comprise a mixing zone (71), a first inlet (29) for one of F′1 and F″1 and a second inlet (30) for the other one of F′1 and F″1. One or both of these inlets may comprise a dispenser in the form of an injector (31) capable of dispensing repeated pulses of fluid into the mixing zone (71). Alternative mixing functions are also possible, for instance a mixing zone permitting mixing by turbulence and/ or diffusion with separate inlets for F′1 and F″1, respectively (not shown). These other mixing functions comprise variants in which an inlet (29,30) as such is considered to be a dispenser.

If no mixing function (28) is present fluid F′1 typically is fluid F1.

The apparatus of FIG. 5 also comprises a separate flow line (arrangement) (75) comprising storing and transporting F″1 to the mixing function (28). This separate flow line (FLmod) merges with main flow line FL1 (1) in the mixing function (28). It typically comprises a storage vessel (64) for fluid F″1 and optionally also a flow meter (59c) and/or a pump (60c) and/or a check valve (62c). The arrangement with a separate flow line (75) preferably also comprises an excess function (80), such as a return flow line, (81) with a pressure release valve and/or a back pressure regulator (82) in the case the second inlet (30) is part of an injector with an electronic pulse control function (17c). Excess flow is preferably returned to the storage container (64) from which fluid dispensed through the injector originates.

If the particle-forming substance has not been included in any fluids (i.e. F1, F′1,F″1, F2 (if present) etc) to be transported in the flow lines of the apparatus), there is typically an extractor function (32) present in the flow line concerned. As described in FIG. 5 this may be in the main flow line FL1 (1), in particular in its upstream part uFL1 (23). The extractor function (32) is typically downstream of the storage vessel (27) as outlined in FIG. 5 and in particular downstream or upstream of a mixing function (28) (if present).

The flow-through extractor function (32) comprises
a) an inlet (65) which in the upstream direction is fluidly connected to the storage vessel (27) for fluid F1, or, if a mixing function (28) is present, to both storage vessel (27) now intended for a fluid F′1 and to storage vessel (64) intended for a fluid F″1 (via the mixing function),
b) an outlet (66) which in the downstream direction is in fluid communication with the dFL1 sublines (1a,b,c . . . ), and
c) an extraction zone (67) positioned between the inlet (65) and the outlet (66) of the extractor function (32) and containing the particle-forming substance in a form that is dissolvable in the fluid solvent F1 (including a mixture of fluids if a mixing function is placed upstream of extractor function (32)).

A mixing function (28) of the kind described above may be included either upstream or downstream of an extractor function (32). Further the mixing function and the extractor function described for FIG. 5 may also be present in other variants of the inventive apparatus, for instance variants illustrated by FIG. 1-7.

Downstream of an extractor function there is typically a back-pressure regulator (83).

If the dispenser at the inlet (29) of the mixing function (28) is an injector, there is preferably an excess function (19) comprising an excess flow line (19a) with a pressure release valve (43′) and/or a back pressure regulator (43) as discussed elsewhere in this specification for main flow line FL1.

As discussed above the pulses of fluid from injectors as well as the temperature of injectors are preferably controlled electronically by control functions (17b,17c) and the temperature of the particle formation chamber (4) and separating function (51) by heating/cooling units (69,70), e.g. based on heat exchange .

FIG. 6

This figure illustrates variants of apparatuses of the invention adapted to spray drying methods of the invention. These variants comprises a main flow line FL1 (1) for a fluid solution containing as a substance to be incorporated in the particles to be formed. The substance may be present as a solute. The main flow line shown is essentially as described for main flow line FL1 of FIG. 2. Main flow line FL2 (2) comprises in its upstream part (33) a source (68), for instance a suitable vessel or container, for a drying gas that may be air or nitrogen. The source (68) may be common for all dFL2 sublines (2a,b,c . . . ) or the individual dFL2 sublines (2a,b,c . . . ) may be connected to separate sources (not shown). Downstream of the source (68) there can be one or more of a flow meter, a pump, a heating/cooling unit etc (none of which is shown).

The upstream part uFL1 (23), the number of dFL1 and dFL2 sublines (1a,b,c . . . ;2a,b,c . . . ), downstream and upstream dFL1 and dFL2 dispensers (5a,b,c . . . ;6a,b,c . . . ;11,a,b,c . . . ) and, the particle formation arrangement (3), the main exit flow line (49) etc may be as outlined in the description of FIG. 1-5. The downstream dFL2 dispensers (11a,b,c . . . ) are typically diffusers. The downstream dFL1 dispensers (5a,b,c . . . ) are typically spray dispensers, for instance injectors or nozzles giving a non-pulsed spray of the fluid solution. Upstream dFL1 dispensers (6a,b,c . . . ) are preferably injectors if the downstream dFL1 dispensers (5a,b,c . . . ) are not. Downstream of the the particle formation arrangement (3) there is typically a back pressure regulator (50a,b,c . . . ) associated with the exit flow line (49a,b,c . . . ) of each particle formation chamber (4a,b,c . . . ) present in the arrangement (3).

FIG. 7

This figure illustrates an apparatus in which particles can be produced and coated within the same flow-through particle formation chamber (4a). For this purpose the apparatuses has three main flow lines FL1 (1), FL2 (2) and FL3 (76), everyone of which has a downstream dispenser (5a,11a,77a) in direct fluid communication with the chamber (4a). FL2 (2) is arranged to provide a flow of fluid through the chamber (4a) with its downstream dispenser (11a) placed at the inlet end of the chamber. The downstream dispenser (5a) of FL1 (1) is connected to the chamber at a position upstream of the position of the connection of the downstream dispenser (77a) of FL3 (76). In order to produce and coat particles in the chamber (4a), the fluid anti-solvent is provided via the downstream dispenser of FL2 (2), the fluid solution containing the particle-forming substance, e.g. as a solute, via the downstream dispenser (5a) of FL1 (1) and the coating agent (modifying agent) via the downstream dispenser (77a) of FL3 (76). Every main flow line FL1 (1), FL (2) and FL3 (76) in FIG. 7 comprises a single subline (1a,2a,76a). One can envisage variants which comprises a) more than one subline/downstream dispenser per main flow line, for instance for one two, or three of the main flow lines shown in FIG. 7, and b) two or more particle formation chambers.

Downstream of the particle formation chamber (4a) there is a particle collection vessel (37). FIG. 7 illustrates also that FL1 (1) and FL3 (76) preferably comprise separate pump functions (60a,60c) with separate flow sensors/meters (59b,59d), separate storage vessels (26,78) and separate excess function (19,79).

In FIG. 7, FL1 (1) and FL3 (76) are adapted for subcritical fluids and FL2 (2) comprises parts that are adapted for supercritical fluids (compare FL″ of FIG. 2). One can envisage that relevant parts of either one or both of FL1 (1) and FL3 (76) may be adapted to supercritical fluids and/or that FL2 (2) may be adapted to subcritical fluids.

Second Aspect: A Method

This aspect comprises a method in which the apparatus as described for the first aspect of the invention can be used. The method comprises the steps of:
i) providing an apparatus as described for the first aspect of the invention, e.g. an apparatus comprising one or more flow-through particle formation chambers and one, two, three or more main flow lines (FL1, FL2, FL3 etc), everyone of which contains
   a) one or more downstream flow-through dispensers in direct downstream fluid communication with said chamber(s), and
   b) upstream of everyone of these downstream dispensers an optional upstream dispenser, with the proviso that said downstream and/or said upstream dispenser(s) in at least one of said main flow lines are actuated flow-through dispensers (=flow-through injectors),
ii) expanding into the particle formation chamber(s) of the apparatus provided in step (i),
   a) a pressurized fluid flow, which contains the substance, e.g. as a solute, through the downstream dispenser(s) of a first main flow line FL1,
   b) optionally a pressurized anti-solvent or drying fluid flow through the downstream dispenser(s) of a second main flow line FL2 into the same particle formation chamber(s) as in (a), and
   c) optionally a pressurized fluid flow containing an agent capable of modifying the particles to be formed through the downstream dispenser(s) of a third main flow line FL3 into the same particle formation chambers as in (a),
iii) collecting the particles formed in said chamber(s)

The desired width (millisec, ms) and frequency (Hz) of the pulses to be used in a particular application and a particular apparatus have at this stage of development to be based on experimental testing. Factors that might be of value to consider are: a) kind of dispensers including the design of the outlet through which fluid is dispensed, b) volume of fluids dispensed in individual pulses, c) kinds of fluids, d) kinds of substances to be incorporated into the particles, e) flow rates through injectors and other dispensers (including relative flow rates between different dispensers), f) pressure drops across the outlets of the dispensers, g) etc. It is believed that useful values for width and frequency can be found within the interval of 0.1 ms och 1 sec/pulse, such as 1 ms to 100 ms which corresponds to 10 000 Hz to 1 Hz, such as 1000 Hz to 10 Hz.

The expanding into the particle formation chamber is carried out under conditions permitting the desired particles to be formed. The expanding according (ii.b) and (ii.c) is occurring simultaneously with the expanding according to (ii.a). Fluid is continuously removed from the chamber during step (ii).

Dispensation through upstream injectors and/or downstream injectors in at least one of the main flow lines are carried out in a pulsed mode as described above for the first aspect of the invention.

One or more of the main flow low lines of the apparatuses provided in step (i) may comprise a mixing function for adding a modifying agent to the fluid flow of such a main flow line. In this case, the method aspect of the invention may comprise that expanding according to at least one of steps (ii.a-c) comprises expanding a fluid flow comprising the modifying agent. The modifying agent may differ or be the same for different main flow lines.

The method aspect also comprises that the particles obtained are further transformed to a desired formulation having a desired composition containing the particles obtained in the inventive apparatus possibly together with one or more suitable additives and/or vehicles and/or excipients. Typical formulations are tablets, capsules, pills, pellets, dispersions, sprays, ointments, solutions etc and being intended for inhalation, oral administration, parenteral administration, injection etc. In the case the formulation/composition comprises a therapeutically active entity, such as a drug, and the vehicle and other additives and constituents/excipients which are present are pharmaceutically acceptable. The method aspect of the invention thus also comprises a method for the manufacture of a pharmaceutical composition or formulation in which the substance to be incorporated in the particles formed in the inventive apparatus may be the therapeutically active entity, a vehicle or some other additive, constituent etc including various excipients .

Physical Characteristics of Produced Particles

The use of the invention is likely to render it possible to controllably and reproducibly produce batches of particles, each of which has particles with a mean particle diameter within the lower part of μm-range, i.e. ≦40 μm, such as ≦30 μm. Typically this means
a) a mean particle diameter in the interval ≦20 μm, such as ≦10 μm or ≦5 μm or ≦3 μm or ≦2 μm or ≦1 μm or ≦0.5 μm or ≦0.25 μm or ≦0.1 μm, with a lower limit typically being 0.025 μm or 0.05 μm or 0.01 or 0.1 μm or 0.5 μm, and/or
b) a particle size distribution with ≧80% of the particles within an interval of a width of ≦30 μm, such as ≦20 μm or ≦15 μm or ≦10 μm or ≦5 μm or ≦3 μm or ≦2 μm, and/or
c) a particle size distribution in which at least 80% of the particles is within a size interval having the width of ≦±75%, such as ≦±50% or ≦±25% of the mean particle diameter.

The width in (b) above includes also batches in which the width is even less, such as ≦1 μm or ≦0.5 μm or ≦0.05 μm or ≦0.025 μm, preferably for batches with particle mean sizes ≦3 μm such as ≦1.5 μm or ≦0.0.75 μm or ≦0.0.25 μm.

The terms “particle size”, “particle size diameter” and “particle size distribution” in this specification refer to values obtained as given in WO 2009072953 and WO 200972950 (XSpray Microparticles AB).

The use of the invention is also likely to support controlled and reproducible production of batches of particles, each of which batch has particles with improved inter-particle homogeneity with respect to morphology features, such as crystal type or degree of amorphousness and/or crystalline characteristics. In other words to facilitate production of batches in which ≧50%, such as ≧60% or ≧70% or ≧80% or ≧90% or ≧95%, of the individual particles of a batch have the same balance between amorphousness and crystalline features and/or between different crystal forms.

Modifying Agents

A modifying agent may be introduced
a) by addition via main flow lines FL1 and FL2 to i) the fluid solution containing the substance to be incorporated into the particles, or ii) the fluid anti-solvent or a drying gas, and/or
b) via an additional main flow line, i.e. a main flow line other that FL1 or FL2.

The agent may be premixed with the fluid to be added to a storage tank or added via a separate flow line to a fluid flow in a main flow line via a mixing function present in the main flow line.

A modifying agent is capable of interfering with the particle formation process by changing:
a) the particles as such, for instance by modifying their size and morphology characteristics and/or their composition and/or other characteristics as discussed above, and/or
b) the solubility of the substance when being present as a solute in a fluid within a main flow line (e.g. FL1 (1) or FL2 (2)) and/or
c) the solubility of the substance in a fluid mixture formed in the particle formation arrangement (3) (if a main flow line other than FL1 is present and used with another fluid, eg. FL2 with fluid F2).

The expression “modifying their composition” in (a) comprises that the modifying agent can be a substance which is incorporated into the particles. The agent may be incorporated as a layer, e.g. an outer layer, or be more or less homogeneously distributed within the individual particles, e.g. by cocrystallisation. In the case the substance is a drug the modifying agent may be a second drug, thus allowing the inventive method to be used for the manufacture of particles containing two or more different drugs.

Modifying agents which are not incorporated into the particles are called make-up agents and are of particular importance. See for instance WO 2009072953 (XSpray Microparticles AB); and WO 2009072950 (XSpray Microparticles AB).

Fluids and Kinds of Processes to be Performed

In a first kind of preferred variants of the invention relevant parts of at least one of the main flow lines, in particular one or both of FL1 or FL2 (1,2), are adapted to a supercritical fluid (compare FIG. 2). The adaptation may extend at least to the downstream dispenser(s) of the main flow line concerned and may include the particle formation chamber(s) (4). Main flow lines which are not adapted to supercritical fluids are adapted to fluids in subcritical fluids, i.e. to fluids in a non-supercritical state, e.g. fluids that are the liquid state (liquids) or in the gas state (gases).

Supercritical state above includes near supercritical state.

The main flow line(s) in a second kind of preferred variants of the invention are adapted for subcritical fluids, e.g. fluids that are in the liquid state or the gas state. In these variants one or both of the main flow lines FL1 and FL2 may be adapted to fluids in the liquid state. The remaining ones of the main flow lines are then adapted to fluids in the gas state.

Other flow lines such as flow lines for transporting fluids containing a modifying agent to be mixed with fluid F1 or fluid F2, i.e. flow lines called FL1mod and FL2mod, respectively, are typically adapted to fluids in the liquid state. See for instance the discussion regarding the mixing function in FIG. 5. Relevant parts of this kind of other flow lines may alternatively be adapted for a supercritical fluid in the case they are merging via a mixing function with a main flow line adapted for a supercritical fluid.

Processes to be carried out in the invention may be illustrated with RESS processes (Rapid Expansion of Saturated Solutions), SAS processes (Solution AntiSolvent precipitation, SEDS processes (Solution Enhanced Dispersion by Supercritical fluids) etc. For the meaning of these terms see WO 2005061090 CENS Delivery AB; WO 2009072953 XSpray Microparticles AB; and WO 2009072950 XSpray Microparticles AB and publication cited in these publications. A RESS-process applied to the present invention comprises expansion of a supercritical or subcritical fluid solution containing the substance into a particle formation chamber via a downstream dispenser of a main flow line transporting the fluid solution. A SAS-process applied to the present invention comprises mixing a fluid solution transported in a main flow line with a fluid anti-solvent transported in another main flow line when entering a particle formation chamber. Mixing is taking place within a downstream dispenser which is common for the main flow lines and/or within the particle formation chamber with simultaneous or subsequent expansion of the fluids into the particle formation chamber. In a SAS-process either one or both of the fluid solvent and the fluid anti-solvent may be in the supercritical or subcritical state at the position of the downstream dispensers, i.e. when entering the particle formation chamber.

In the case a main flow line of the apparatus is adapted to a fluid which is in the gas state, the fluid may be a drying gas as described for FIG. 6 and the apparatus used in a spray drying process. This kind of process may utilize the principle of RESS, SAS, SEDS etc.

Various kinds of suitable fluids and ingredients to be added and how to select them are discussed in WO 2005061090 CENS Delivery AB; WO 2009072953 XSpray Microparticles AB; and WO 2009072950 XSpray Microparticles AB and publication described in them.

Illustrative fluids that can be used as a supercritical fluid in the invention are typically gaseous at room temperature and atmospheric pressures, e.g. selected amongst substances such as supercritical carbon dioxide, nitrous oxide, sulphur hexafluoride, ethane, ethylene, xenon, trifluoromethane, and chlorotrifluoromethane and mixtures of this kind of fluids. A supercritical fluid can be used either as a solvent (fluid solution) or as a fluid anti-solvent depending on whether or not the substance to be incorporated into the particles is soluble or insoluble in the fluid.

Illustrative fluids that can be used in a subcritical state in the invention are typically found amongst inorganic and organic liquids, with preference for those that are volatile at room temperature and atmospheric pressure. A preferred inorganic liquid is water including also aqueous liquids. A subcritical fluid can be used either as a solvent (fluid solution) or as a fluid anti-solvent depending on whether or not the substance to be incorporated into the particles is soluble or insoluble in the fluid.

The Substance to be Incorporated into the Particles

The term “substance” shall in the context of the invention be interpreted broadly including single compounds as well as mixtures of compounds. Many of the substances to be used in the invention are biologically active or works as a vehicle, an additive, an excipient etc in the compositions and formulations into which the particles are to be incorporated after their production. The most important substances are to be used pharmacologically meaning that the term “biologically active” mostly also stands for “therapeutically active”. The substance may exhibit polypeptide structure and/or non-polypeptide structure, such as nucleotide structure, carbohydrate structure, lipid structure, steroid structure, be a hormone, a sedative, an anti-inflammatory substance etc and includes the classes of therapeutically active compounds given below.

Modifying agents of the types described above may also be incorporated into the particles.

When the produced particles are to be used in a pharmaceutical composition the substance may be a) a therapeutically active entity or compound, e.g. a drug, b) a vehicle, c) an agent determining release characteristics of the active entity from the particles or the composition, d) an agent determining characteristics for in vivo absorption of the particles, the composition and/or the therapeutically active entity of the composition, e) various other substances used as excipients etc.

Preferred substances are in pure form in solid form (+25° C.).

Examples of therapeutic classes of therapeutically active compounds which are of interest to be used as the substance to be incorporated into particles according to the invention are: antacids, anti-inflammatory substances, coronary dilators, cerebral dilators, peripheral vasodilators, anti-infectives, psychotropics, antimanics, stimulants, antihistamines, anti-cancer therapeutic compounds, laxatives, decongestants, vitamins, gastrointestinal sedatives, antidiarrheal preparations, anti-anginal therapeutic compounds, vasodilators, antiarrythmics, anti-hypertensive therapeutic compounds, vasoconstrictors and migraine treatments, anticoagulants and antithrombotic therapeutic compounds, analgesics, anti-pyretics, hypnotics, sedatives, anti-emetics, anti-nauseants, anti-convulsants, neuromuscular therapeutic compounds, hyper- and hypoglycemic agents, thyroid and anti-thyroid preparations, diuretics, anti-spasmodics, uterine relaxants, mineral and nutritional additives, anti-obesity therapeutic compounds, anabolic therapeutic compounds, erythropoietic therapeutic compounds, anti-asthmatics, expectorants, cough suppressants, mucolytics, anti-uricemic therapeutic compounds, and therapeutic compounds or substances acting locally in the mouth

### Experimental Part

### EXAMPLE 1

### Pure Drug Substance Particle Formation by RESS (Rapid Expansion of Saturated Solution)

1. Place piroxicam in an extraction vessel and pump 25 g/min pure CO₂ at 150-1000 bar and 50-150° C. through the extraction vessel to obtain a flow of a fluid solution containing piroxicam (a few mg of piroxicam will be dissolved per g CO₂).
3. Pass the flow of the solution from step (1) by the use of an actuated injector (pulsed flow) into a flow-through particle formation chamber at 1 bar in order to form particles within the nanometer to micrometer range in the chamber.
4. Allow carbon dioxide to continuously leave the chamber during the formation of the particles.

For solubility data refer to “Application of Supercritical Carbon Dioxide for the Preparation of a Piroxicam-β-Cyclodextrine Inclusion compound”, T. Van Hees et al., Pharmaceutical Research, Vol. 16, No. 12, 1999

### EXAMPLE 2

### Pure Drug Substance Particle Formation by SAS (Solvent Anti-Solvent)

1. Inject a pulsed flow of a solution of 0.8% nicotinic acid in ethanol at 1 ml/min by the use of an actuated injector into a flow of 100 g/min supercritical CO₂ at 90 bar and 90° C. passing through a flow-through particle formation chamber in order to obtain sub- to micrometer particles in the chamber.
2. Allow carbon dioxide and ethanol to continuously leave the chamber during the formation of the particles.

### EXAMPLE 3

### Particle Formation and Coating by Synchronized SAS (Solvent Anti-Solvent)

1. Use a first actuated injector to deliver a pulsed flow of a solution of 0.8% nicotinic acid in ethanol at 1 ml/min into a flow of 100 g/min supercritical CO₂ at 90 bar and 90° C. which passes through a particle formation chamber in order to obtain sub- to micrometer particles.
2. Use a second actuated injector to deliver a pulsed flow of a solution of 0.1% of PVP K30 in acetone at a flow of 0.1 ml/min to the flow of supercritical CO₂ at a position downstream of the first injector in order to coat the particles formed by injection of the solution. The pulses of the two injectors are synchronized with each other (flow pulses are in synchrony or asynchrony).
3. Allow carbon dioxide and the ethanol and acetone delivered to the chamber in steps (1) and (2) to continuously leave the chamber during the formation of the particles.

### EXAMPLE 4

### Solid Dispersion Formation by Spray Drying

1. Deliver a pulsed flow of 5% (w/v) solution of piroxicam/PVP K25 (weight ratio=1:4) in a mixture of ethanol/acetone (volume ratio=1:4) at a flow of 1-5 ml/min by an actuated injector into a flow of a drying gas set to 10-50 m³/hour which passes through a particle formation chamber at 60-110° C.
2. Allow the gas/ethanol/acetone mixture to continuously leave the chamber.

For spray drying methods using standard equipment refererence is made to “Formation and Characterization of Solid dispersions of Piroxicam and Polyvinylpyrrolidone Using Spray drying and Precipiatation with Compressed Antisolvent”, K. Wu et al., Journal of pharmaceutical Sciences, Vol. 98, No. 7, July 2009.

### EXAMPLE 5

### Pure Drug Substance Particle Formation by SAS (Solvent Anti-Solvent)

1. Deliver pulsed flow of a solution of 9% fluticasone propionate in tetrahydrofuran at 2.5 ml/min using an actuated injector into a flow of 10 g/min hexane at 1 bar and 20° C. passing through a particle formation chamber in order to obtain sub- to micrometer particles in the chamber.
2. Allow hexane and tetrahydrofuran to continuously to leave the chamber during the formation of the particles.

While the invention has been described and pointed out with reference to operative embodiments thereof, it will be understood by those skilled in the art that various changes, modifications, substitutions and omissions can be made without departing from the spirit of the invention. It is intended therefore that the invention embraces those equivalents within the scope of the claims which follow.

1.-15. (canceled)

16. An apparatus for production of particles of a substance by dynamic precipitation of said substance from a fluid solution containing said substance dissolved in a fluid solvent, said apparatus comprising:
A1) a first main flow line, FL1, intended for a first pressurized flow, FF1, of a first fluid, F1, and encompassing in its downstream part, dFL1, one, two or more separate dFL1 sublines, where
a) every dFL1 subline
comprises one or two serially linked pressurized flow-through dispensers for F1, and
is functionally equal to the other dFL1 sublines, and
b) each of said one or two serially linked pressurized flow-through dispensers
has an inlet and an outlet for flow, and
is functionally equal with corresponding serially linked pressurized flow-through dispensers in said other dFL1 sublines, and
B1) a particle formation arrangement comprising
a) one or more flow-through particle formation chambers every one of which has an inlet arrangement and an outlet arrangement, and
b) downstream serially linked pressurized flow-through dispensers of said one or two serially linked pressurized flow-through dispensers with one, two or more serially linked pressurized flow-through dispensers per flow-through particle formation chamber, wherein at least one of said one or two serially linked pressurized flow-through dispensers is an injector which is capable of being repeatedly activated enabling a pulsed flow through an outlet of said injector.

17. The apparatus of claim 16, further comprising
A2) a second main flow line, FL2, intended for a second pressurized flow, FF2, of a second fluid, F2, and encompassing in its downstream part, dFL2, one, two or more dFL2 sublines, where
a) every dFL2 subline
comprises one or two serially linked pressurized flow-through dispensers for F2, and
is functionally equal to the other dFL2 sublines, and
b) each of said one or two serially linked pressurized flow-through dispensers
has an inlet and an outlet for flow, and
is functionally equal with corresponding serially linked pressurized flow-through dispensers in said other dFL2 sublines, and
B2) said particle formation arrangement further comprises downstream serially linked pressurized flow-through dispensers of said dFL2 sublines as part of said inlet arrangement with one, two or more dFL2 downstream serially linked pressurized flow-through dispensers per inlet arrangement and flow-through particle formation chamber, and with every downstream dFL2 serially linked pressurized flow-through dispenser connected to a flow-through particle formation chamber
i) via a downstream FL1 serially linked pressurized flow-through dispenser, or
ii) directly into said flow-through particle formation chamber, permitting mixing of flow originating from FL1 with flow originating from FL2,
wherein at least one of said one or two serially linked pressurized flow-through dispensers in every dFL1 subline and/or in every dFL2 subline is an injector which is capable of being repeatedly activated enabling a pulsed flow through its outlet.

18. The apparatus of claim 16, comprising one or more additional main flow lines each of which comprises one or more sublines everyone of which comprises one or two serially linked pressurized flow-through dispensers where downstream serially linked pressurized flow-through dispensers are part of said particle formation arrangement and in downstream fluid communication with said flow-through particle formation chambers.

19. The apparatus of claim 16, wherein said subline(s) of one of said main flow lines is(are) in fluid communication with a same flow-through particle formation chamber at position(s) that is/are upstream of position(s) for fluid communication of said subline(s) of another of said main flow lines with said same flow-through particle formation chamber.

20. The apparatus of claim 19, wherein said another of said main flow lines comprises two or more sublines and at least two of these sublines are in fluid communication with said same flow-through particle formation chamber at different downstream distances from said position(s) where said subline(s) of said one of said main flow lines are in fluid communication with said same flow-through particle formation chamber.

21. The apparatus of claim 16, comprising an excess function associated with each of one or more of said injectors for taking care of undesired increase in pressure in said first main flow line upstream of said each one or more of said injectors.

22. The apparatus of claim 17, wherein activation of an injector in a dFL1 subline and/or a dFL2 subline is/are capable of being synchronized with activation of corresponding injectors in other dFL1 sublines and/or other dFL2 sublines.

23. The apparatus of claim 16, wherein two main flow lines are present in said apparatus and that every downstream serially linked pressurized flow-through dispenser of one of these two main flow lines is integrated with a downstream serially linked pressurized flow-through dispenser of the other one of these two main flow lines to a common downstream serially linked pressurized flow-through dispenser with a common outlet which is in downstream fluid communication with a flow-through particle formation chamber.

24. The apparatus of claim 16, wherein two main flow lines are present in said apparatus and flow from every downstream serially linked pressurized flow-through dispenser of one of these two main flow lines and flow from every downstream serially linked pressurized flow-through dispensers of the other one of these two main flow lines are entering a same flow-through particle formation chamber via separate parts of an inlet arrangement.

25. The apparatus of claim 16, wherein an upstream part of said first main flow lines of said apparatus comprises an extractor function in which said substance to be incorporated in said particles is extracted into a fluid flow passing through said extractor function.

26. The apparatus of claim 16, wherein said first main flow line is adapted to transport a fluid solution containing said substance in the form of a solute which is to be incorporated into said particles.

27. The apparatus of claim 26, wherein two or more main flow lines are present in said apparatus and each of at least one of these two or more main flow lines is adapted to an anti-solvent fluid.

28. The apparatus of claim 17, wherein said apparatus is capable of permitting a flow of a fluid, which is in a supercritical state, in at least one of said first and second main flow lines of said apparatus at least to a position of said downstream serially linked pressurized flow-through dispenser(s) of said at least one of said first and second main flow lines.

29. The apparatus of claim 17, wherein said apparatus is capable of permitting a flow of a fluid in a subcritical state in at least one of said first and second main flow lines of said apparatus.

30. A method for producing particles of a substance comprising the steps of:
i) providing an apparatus according to claim 16,
ii) expanding into flow-through particle formation chamber(s) of said apparatus provided in step (i):
a) a pressurized fluid flow, which contains said substance through downstream serially linked pressurized flow-through dispenser(s) of a first main flow line, FL1,
iii) collecting said particles formed in said particle formation chamber(s).

31. The method of claim 30, wherein expanding into said flow-through particle formation chamber(s) comprises expanding into said flow-through particle formation chamber(s) of said apparatus provided in step (i):
b) a pressurized anti-solvent or drying fluid flow through downstream serially linked pressurized flow-through dispenser(s) of a second main flow line, FL2, into said particle formation chamber(s) as in (a).

32. The method of claim 30, wherein expanding into said flow-through particle formation chamber(s) comprises expanding into said flow-through particle formation chamber(s) of said apparatus provided in step (i):
c) a pressurized fluid flow containing an agent capable of modifying said particles through downstream dispenser(s) of a third main flow line, FL3, into said particle formation chambers as in (a).

33. The method of claim 30, wherein
said substance is biologically or pharmacologically active or is an excipient in a pharmaceutical composition, and
said method comprises transforming said particles after step (iii) to a pharmaceutical composition containing said particles.
